(19) United States
(12) Patent Application Publication
(10) Pub. No.: US 2008/0185208 A1
(43) Pub. Date: Aug. 7, 2008

(54) Motorcycle cruise arm assembly

(76) Inventor: Darron B. May, Stillwater, MN (US)

Correspondence Address: John M. Weyrauch;DICKE, BILLIG & CZAJA, PLLC, Suite 2250, 100 South Fifth Street, Minneapolis, MN, 55402, US

(21) Appl. No.: 11/702,358

(22) Filed: Feb. 5, 2007

(51) Int. Cl. B60N 3/06; B60K 5/00

(52) U.S. Cl. 180/291

(57) ABSTRACT

A motorcycle cruise arm assembly includes a pair of arm assemblies mountable to a motorcycle frame. Each arm assembly includes a mount block and an arm rotatably mountable to the mount block. The mount block includes a body and a head attached to the body, where the body defines a substantially planar surface configured for attachment to the motorcycle frame and the head defines an engagement surface opposite the substantially planar surface. The arm includes a first end opposite a second end, where the first end is configured to be rotatably mountable to the head of the mount block. A second end of each arm is configured to connect to either a foot peg or a angled arm. A support arm connects between the mount blocks of each arm assembly.

### BACKGROUND

The present invention generally relates to foot supports for a motorcycle rider, and more particularly, the present invention relates to an adjustable cruise arm attachable to a motorcycle for supporting a foot peg.

Motorcycle owners have shown a strong interest in customizing their motorcycles by adding accessories to enhance functionality and appearance. One such accessory includes opposing foot pegs forward mounted to opposing foot boards that permit riders to stretch their legs forward for increased comfort when at cruising speeds. The present invention is a cruise arm assembly that is mountable to a frame of the motorcycle for supporting a foot peg at a desired location for a motorcycle rider.

### SUMMARY OF THE INVENTION

The present invention comprises a cruise arm assembly configured to be mounted to a motorcycle frame having spaced first and second frame members, each frame member having first and second sides. The cruise arm assembly comprises a first arm assembly, a second arm assembly and a support arm. The first arm assembly includes a first mount block configured for attachment to the first side of the first frame member. The first arm assembly further includes a first arm having a first end opposite a second end, the first end of the first arm is rotatably mountable to the first mount block. The second arm assembly includes a second mount block configured for attachment to the first side of the second frame member, and a second arm having a first end opposite a second end. The first end of the second arm is rotatably mountable to the second mount block. The support arm has opposing ends, each of engage a respective one of the second sides of each frame member adjacent to the first and second mount blocks.

### BRIEF DESCRIPTION OF THE DRAWINGS

FIG. 1 is a perspective view of a cruise arm assembly attached to a motorcycle frame according to one embodiment of the present invention.

FIG. 2A is a perspective view of a mount block of the cruise arm assembly shown in FIG. 1.

FIG. 2B is a top view of the mount block shown in FIG. 2A.

FIG. 3A is a perspective view of an extension arm of the cruise arm assembly shown in FIG. 1.

FIG. 3B is another perspective view of the extension arm shown in FIG. 3A.

FIG. 4 is a perspective view of a clevis that is attachable to an end of the extension arm shown in FIGS. 3A and 3B.

FIG. 5A is an exploded perspective view of a support arm of the cruise arm assembly shown in FIG. 1.

FIG. 5B is a perspective view of the assembled support arm of FIG. 5A.

FIG. 6 is a simplified diagrammatical view of the support arm of FIG. 5B positioned relative to a motorcycle frame.

FIG. 7 is a perspective exploded view of an extension arm assembly according to another embodiment of the present invention.

FIG. 8 is a perspective view of the extension arm assembly of FIG. 7 attached to a motorcycle frame.

FIG. 9 is a perspective exploded view of extension arm assembly with an alternative mount block according to one embodiment of the present invention.

FIG. 10 is a perspective view of a cruise arm assembly utilizing the mount block of FIG. 9 and attached to a motorcycle frame.

FIG. 10A is a perspective view of a cruise arm assembly including the extension arm assembly shown in FIG. 9 with the motorcycle frame removed.

### DETAILED DESCRIPTION

The present inventions relate to an improved cruise arm assembly for use with a motorcycle. The cruise arm assembly can be bolted directly to the frame of the motorcycle, providing a more durable, secure and stable foot rest for a motorcycle rider. In addition, the cruise arm is adjustable to provide a foot peg location on a motorcycle that can be moved to accommodate the leg length of the motorcycle rider. A variety of frame-mounted cruise arm assemblies are described below, including one embodiment that positions the cruise arm foot pegs adjacent to and outside of the existing foot boards, and a separate embodiment that positions the cruise arm foot pegs well forward of the existing foot boards.

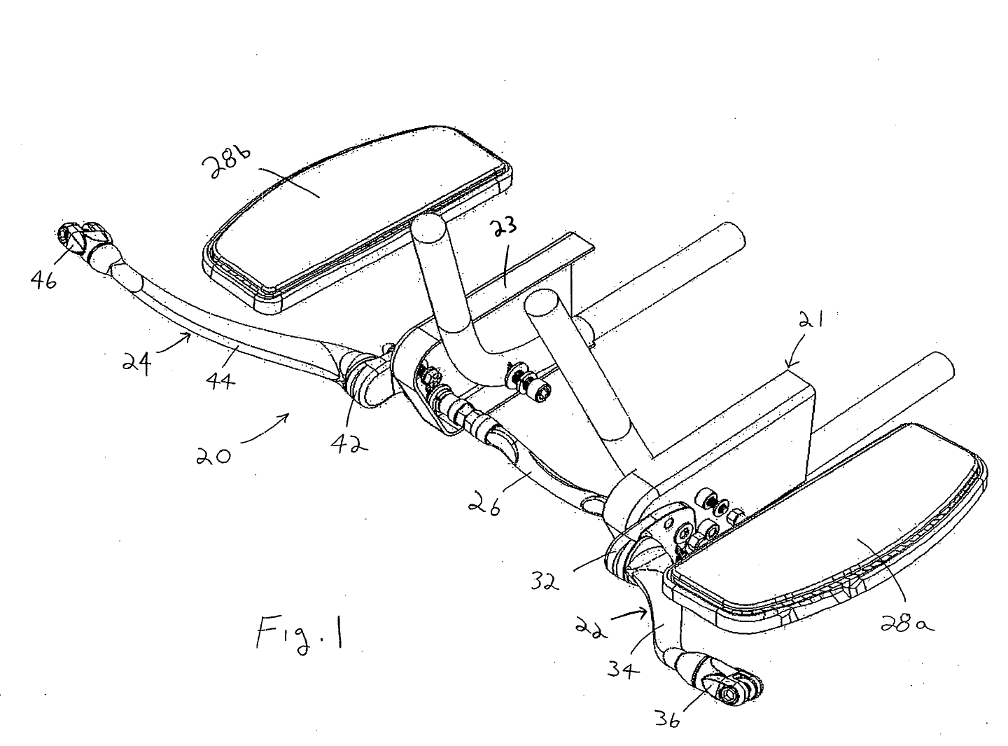

FIG. 1 is a perspective view of a cruise arm assembly 20 mounted to a motorcycle frame 21 in accordance with the present invention. Cruise arm assembly 20 includes a first extension arm assembly 22 mounted to a first frame member 21, a second extension arm assembly 24 mounted to a second frame member 23, and a support arm 26 extending between frame members 21 and 23 and coupled thereto relative to the mounting location of extension arm assemblies 22, 24. As oriented in FIG. 1, first extension arm assembly 22 is a left extension arm assembly mounted to a left hand side of motorcycle frame member 21, and second extension arm assembly 24 is a right extension arm assembly mounted to a right hand side of motorcycle frame member 23. Assemblies 22, 24 are each independently adjustable and are configured to position foot pegs (not shown) attached to ends of assemblies 22, 24 in front of and above foot boards 28a and 28b. Support arm 26 extends between assemblies 22, 24 to provide increased stability of assembled cruise arm assembly 20.

First extension arm assembly 22 includes a first mount block 32 that is bolted to an outer portion of frame member 21, a first elongate extension arm 34 coupled to first mount block 32, and a first clevis 36 coupled to first extension arm 34. In general, first extension arm 34 is movable relative to first mount block 32, and clevis 36 is independently movable relative to first extension arm 34. When a foot peg is attached to clevis 36, assembly 22 can be adjusted fore and aft to provide optimal foot peg positioning and comfort according to the leg length of the motorcycle rider.

Second extension arm assembly 24 is similar to first extension arm assembly 22 and includes a second mount block 42 that is bolted to an outer portion of frame member 23, a second elongate extension arm 44 coupled to second mount block 42, and a second clevis 46 coupled to second extension arm 44. Mount blocks 32 and 42 are not necessarily identical, and can include differences in shape and size that enable the mount blocks 32, 42 to be bolted different sides or styles of motorcycle frames.

Support arm 26 is adjustable along its length, and can be “shortened” for insertion between frame members 21, 23 and “lengthened” to rigidly couple between mount blocks 32, 42. Support arm 26 is generally inserted between the opposing frame members 21, 23 after extension arm assemblies 22, 24 are mounted to frame 21. In one embodiment, support arm 26 is secured relative to frame members 21, 23 adjacent to mount blocks 32, 42 at a point that is offset relative to the connection point of extension arms 34, 44 to mount blocks 32, 42.

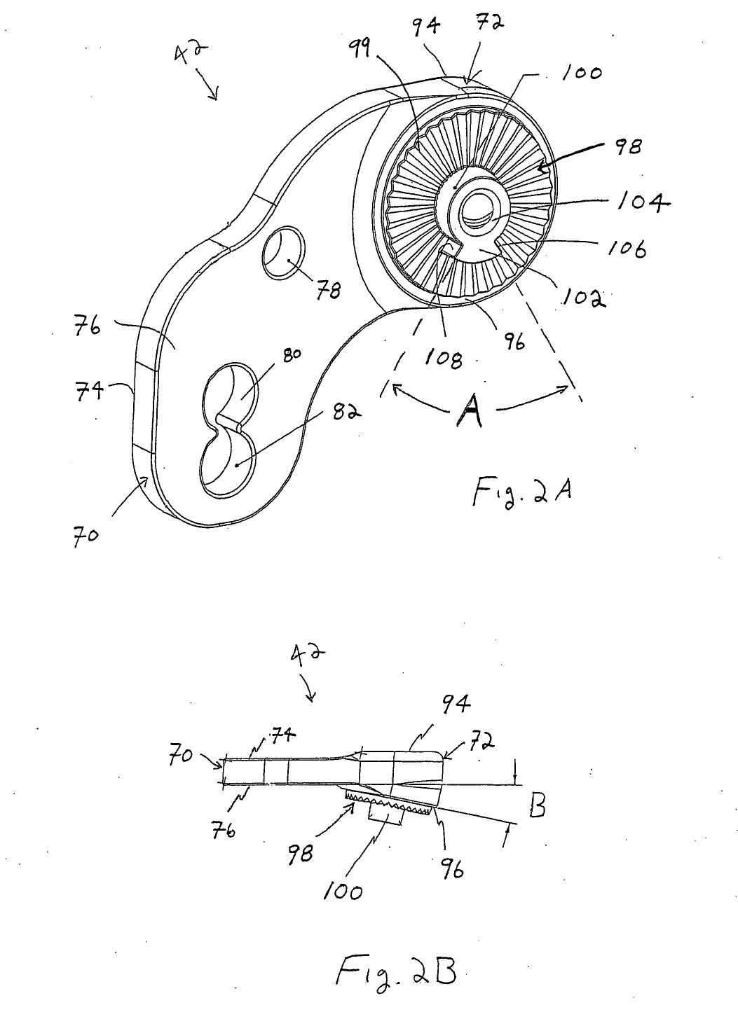

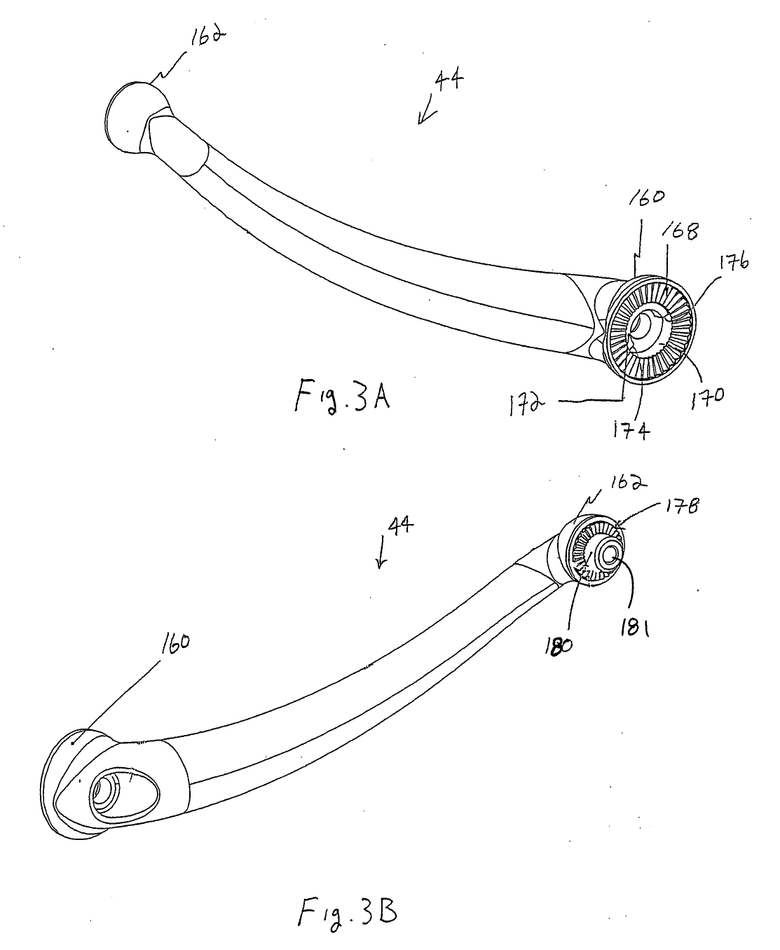

FIG. 2A is a perspective view of second mount block 42, which is similar to mount block 32. Mount block 42 includes a body 70 and a head 72 attached to body 70. Body 70 includes a first face 74 opposite a second face 76, where first face 74 defines a substantially planar surface that is suited for mounting flush to motorcycle frame member 23 (FIG. 1).

Body 70 defines bore 78 and bores 80, 82 that extend between the faces 74, 76. Bore 78 is configured to receive a first bolt and nut pair that attaches mount block 42 to a first point of frame member 23, and one of bores 80, 82 is configured to receive a second bolt and nut pair that selectively attaches mount block 42 to a second point of frame member 23. In this manner, mount block 42 is rigidly secured to two locations of frame member 23 in a manner that enables mount block 42 to accommodate multiple motorcycle models/frame geometries.

Head 72 includes a first face 94 opposite a second face 96, where second face 96 defines an engagement surface 98. Engagement surface 98 includes a series of radial teeth 99 extending from second face 96. The teeth 99 of the engagement surface 98 are generally sawtooth in shape. In one embodiment, head 72 includes a hub 100 projecting from engagement surface 98. Hub 100 defines a central threaded bore 104 and includes an offset lug 102.

Engagement surface 98 and hub 100 combine to form a splined attachment mechanism for coupling to extension arm 44 (FIG. 1). In one embodiment, lug 102 defines an included angle A extending between a first stop surface 106 and a second stop surface 108. Angle A extends between about 50 degrees to about 80 degrees, and preferably angle A is about 70 degrees. When mount block 42 is assembled to the motorcycle frame, extension arm 44 couples to mount block 42 via a bolt (not shown) threaded into bore 104. Engagement surface 98 mates with a similar engagement surface of extension arm 44 to assist in fixing extension arm 44 relative to mount block 42. First and second stop surfaces 106, 108 of offset lug 102 are provided to impede rotation of extension arm 44 relative to mount block 42 and limit the rotational arc of assembled extension arm 44 to between about 0-290 degrees, such that assembled extension arm 44 cannot rotate fully and contact the ground.

FIG. 2B is a top view of mount block 42 illustrating that second face 96 is non-parallel to first face 94. For example, second face 96 is tilted at an angle B relative to first face 94 by between 5-30 degrees, and preferably second face 96 is tilted relative to first face 94 by about 10 degrees. In this manner, when substantially planar first surface 74 of body 70 is mounted flush to motorcycle frame member 23, engagement surface 98 of head 74 is biased away from motorcycle frame member 23, which offsets extension arm 44 (FIG. 1) in an ergonomic manner away from the frame member 23. Body 70 is generally mounted to frame member 23 (FIG. 1) via a pair of bolts, and support arm 26 (FIG. 1) couples to a portion of one of the bolts. Extension arm 44 couples to engagement surface 98 of head 72, and is thus laterally offset from support arm 26.

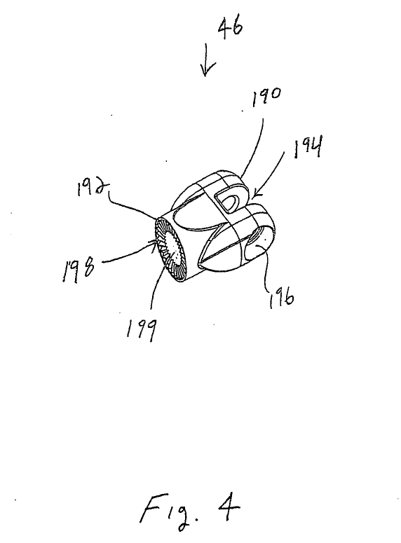

FIG. 3A is a perspective view of second extension arm 44. With additional reference to FIG. 1, second extension arm 44 is a right hand extension arm of cruise arm assembly 20 that is substantially similar to the first (or left hand) extension arm 34. It is to be understood that although the description is directed to second extension arm 44, it applies equally to first extension arm 34.

Extension arm 44 includes a first end 160 and a second end 162 opposite first end 160. First end 160 defines an engagement surface 168 that is configured to mate and engage with engagement surface 98 (FIG. 2A) of mount block 42. In one embodiment, first end 160 defines a mounting recess 170, and a semi-circular inner wall 172 that defines a first stop end 174 and a second stop end 176. Mounting recess 170 is configured to receive the lug 102 (FIG. 2A) projecting from head 72 of mount block 42 (FIG. 2A). The first and second stop ends 174, 176 of semi-circular inner wall 172 are configured to contact stop surfaces 106, 108 (FIG. 2A) of lug 102 and restrict radial travel of extension arm 44 relative to mount block 42. In particular, when extension arm 44 is coupled to mount block 42, first stop end 174 is positioned to contact first stop surface 106 when arm 44 rotates relative to block 42, and second stop end 176 is positioned to contact second stop surface 108 when arm 44 rotates relative to block 42.

FIG. 3B illustrates another perspective view of second extension arm 44 illustrating second end 162. Second end 162 defines an engagement surface 178 and a hub 180 projecting from engagement surface 178. A central bore 181 through hub 180 permits attachment of a clevis 46 (FIG. 1) for connection of a foot pet.

FIG. 4 is a perspective view of second clevis 46. Second clevis 46 is similar to first clevis 36 and includes a first end 190 linearly opposite a second end 192. First end 190 defines a recess 194 sized to receive an extension of a known male foot peg, for example. A threaded bore 196 is provided to receive a fastening bolt that retains the foot peg within recess 194. Second end 192 defines a clevis engagement surface 198 and a bore 199 that is sized to receive hub 180 of end 162 of extension arm 44 (FIG. 3B). In general, second clevis 46 is removably attachable to second end 162 of extension arm 44 (FIG. 3B). For example, a threaded bolt can be employed to secure clevis 46 to second end 162 of extension arm 44 prior to attaching of the foot peg within recess 194.

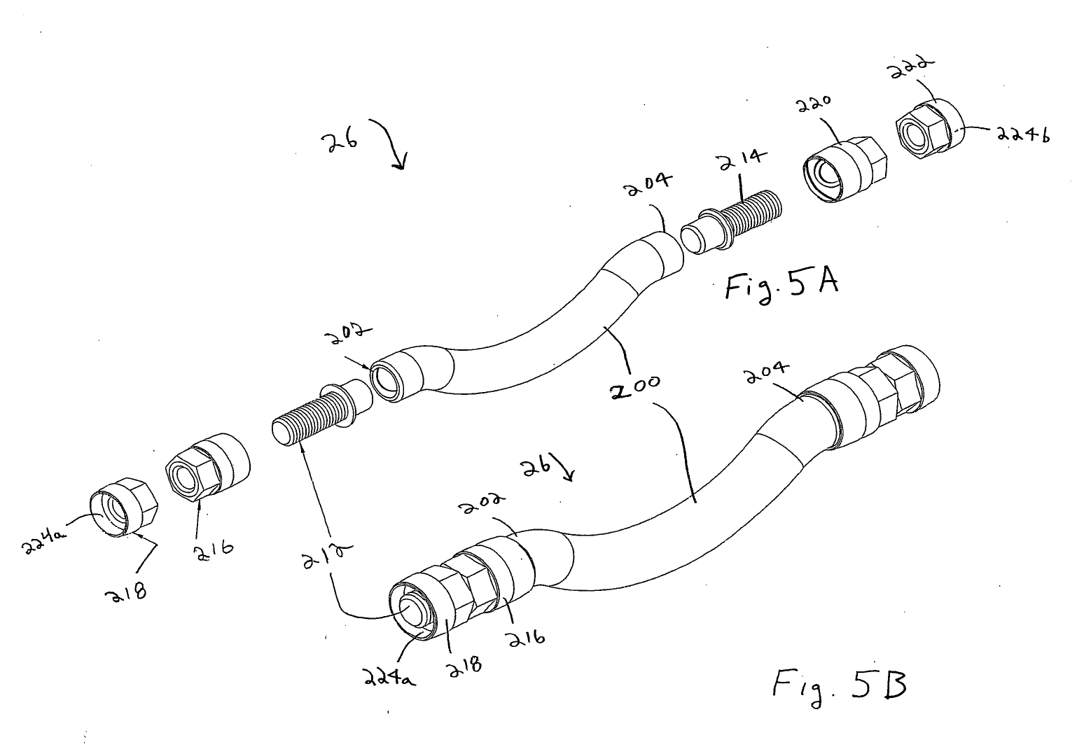

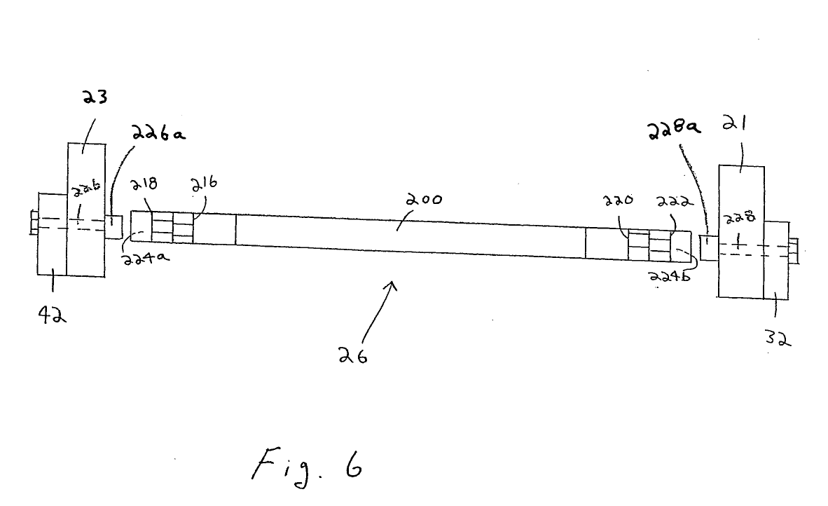

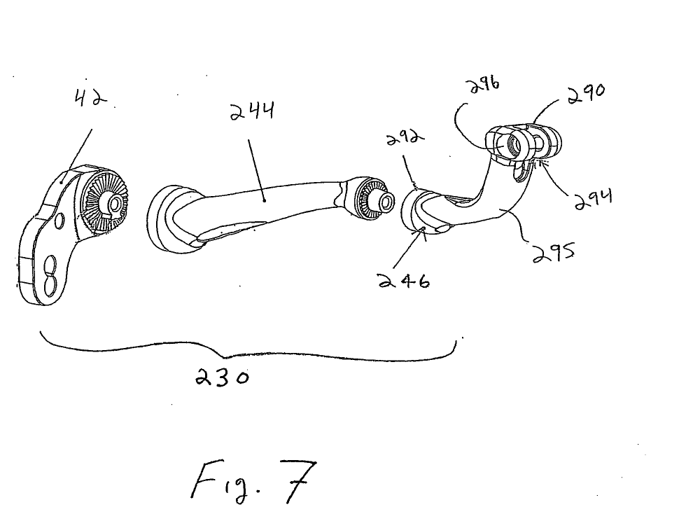

FIGS. 5A and 5B show exploded and assembled perspective views of a support arm 26, respectively. Support arm 26 is a metal strut and includes a curved central portion 200 having a first end 202 and a second end 204. First end 202 is configured to receive a first threaded post 212 and second end 204 is configured to receive a second threaded post 214. Threaded posts 212, 214 are provided as separate components welded or attached to ends 202, 204, respectively. However, it is to be understood that posts 212, 214 could be integrally formed to extend from respective ends 202, 204 of central portion 200.

Support arm 26 is adapted to be length-adjustable. A first inner skirt 216 and a first outer skirt 218 are threaded over first threaded post 212, and a second inner skirt 220 and a second outer skirt 222 are threaded over second threaded post 214. Each of outer skirts 218, 222 defines a respective cavity 224a, 224b sized to receive a cap head of a bolt, such as are associated with the bolts that attach mount blocks 32, 42 to frame members 21, 23 (FIG. 1).

Turning skirts 216, 218 clockwise relative to threaded post 212 will retract skirts 216, 218 toward brace portion 200, effectively shortening an overall length of support arm 26. Conversely, turning skirts 216, 218 counter-clockwise relative to threaded post 212 will extend skirts 216, 218 away from brace portion 200 and over an end of threaded post 212, effectively lengthening the overall length of support arm 26. Skirts 220, 222 retract and extend relative to threaded post 214 in a manner that is similar to skirts 216, 218.

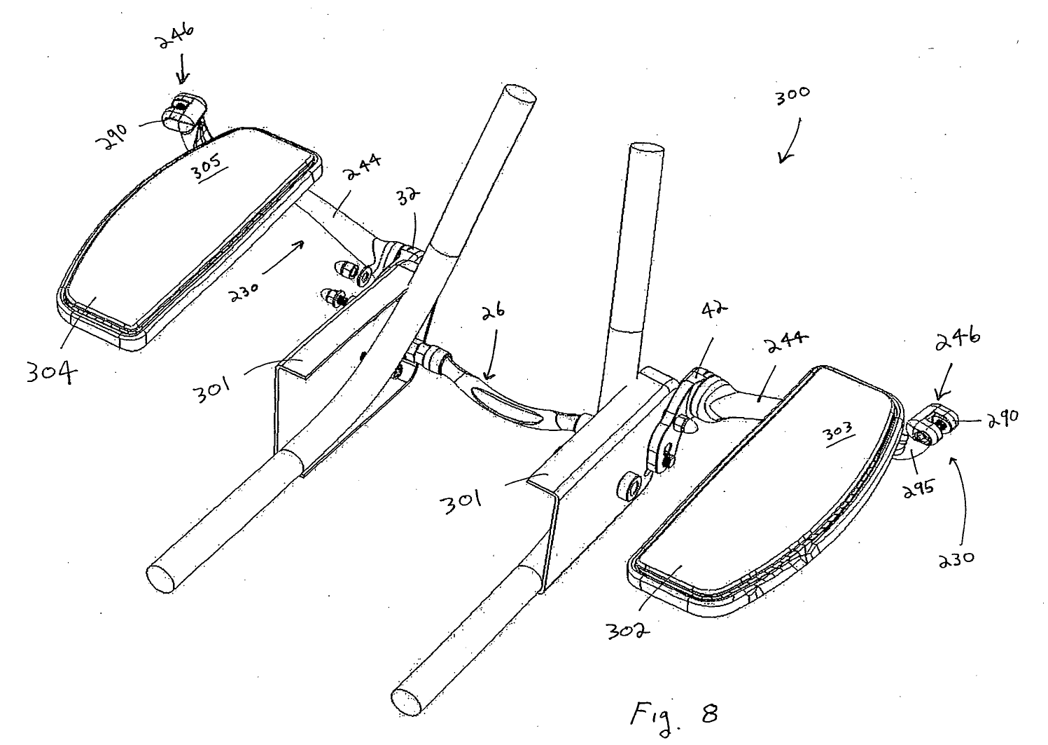

During assembly, the rotation of skirts 216, 218 and 220, 222 clockwise relative to threaded posts 212, 214 effectively shortens support arm 26 and enables support arm 26 to fit between frame 21, as better illustrated in FIG. 6 below.

FIG. 6 is a diagrammatical view of support arm 26 positioned between motorcycle frame members 21, 23 prior to attachment with opposing mount blocks 32, 42. In this simplified front view, a bolt 226 secures mount block 42 to an outer surface of frame member 23 such that a cap head 226a of bolt 226 projects from an inner surface of frame member 23. Similarly, bolt 228 secures mount block 32 to an opposing outer surface of frame member 21 such that a cap head 228a of bolt 228 projects from an inner surface of frame 21. Support arm 26 is diagrammatically illustrated positioned between frame members 21, 23 and aligned with cap heads 226a, 228a.

Turning outer skirts 218 and 222 counter-clockwise moves skirts 218, 222 outward and engages cavities 224a, 224b over respective bolt cap heads 226a, 228a. Thereafter, each outer skirt 218, 222 is turned an additional % turn counter-clockwise to tension support arm 26 between frame members 21, 23. Inner skirts 216, 220 are then turned counter-clockwise to “jamb” against outer skirts 218, 222, respectively, and prevent outer skirts 218, 222 from vibrating loose from their extended positions. In this manner, support arm 26 is tensioned between bodies of mount blocks 32, 24 to rigidly support each extension arm assembly 22, 24.

Components of first extension arm assembly 22 and second extension arm assembly 24 can be fabricated from any suitable support bearing material appropriate for use on a motorcycle. Preferably, components of assemblies 22, 24 are either machined or cast from metal and include a corrosion resistant coating, such as chrome plating, for example. Exemplary embodiments provide components of first extension arm assembly 22 and second extension arm assembly 24 fabricated from steel and coated with a high polish chrome plating.

FIG. 7 is a perspective exploded view of an extension arm assembly 230 according to another embodiment of the present invention. Extension arm assembly 230 is similar to extension arm assembly 24 illustrated in FIG. 1 and includes the same mount block 42 and a similar extension arm 244. Extension arm assembly 230 further includes an angled clevis arm 246 that couples with extension arm 244. Extension arm 244 extends laterally away from mount block 42, and angled clevis arm 246 has both a laterally extending portion and a vertically extending portion that enables clevis arm 246 to extend under and upward adjacent to a floor board attached to a motorcycle frame.

Angled clevis arm 246 includes a first end 290 separated from a second end 292 and an angled member 295 extending between the ends 290, 292. In one embodiment, angled member 295 extends laterally from second end 292, includes an angled portion that jogs about 90 degrees about midway between ends 290, 292, and has a vertical portion that extends to first end 290. First end 290 is similar to end 190, and second end 292 is similar to second end 192 of clevis 46 (FIG. 4). First end 290 defines a recess 294 sized to receive an extension of a known male foot peg, for example, and a threaded bore 296 is provided to accommodate a fastening bolt that retains the foot peg within recess 294. Clevis arm 246 is preferably fabricated from steel and includes a high polish chrome plating, similar to the components described in FIG. 1 above, although other base materials and coatings are also acceptable.

FIG. 8 is a perspective view of a cruise arm assembly 300 including extension arm assembly 230 shown in FIG. 7 attached to a motorcycle frame members 301. A first foot board 302 having a foot surface 303 is mounted to a right side frame member 301, and a second foot board 304 having a foot surface 305 is mounted to a left side frame member 301. Mounting brackets that attach foot boards 302, 304 to frame members 301 are not shown as the brackets are not critical to the invention, and their absence provides a better view of cruise arm assembly 300.

With additional reference to FIG. 6, mount blocks 32, 42 are bolted to an outer surface of frame members 301 such that cap heads 228a, 226a of mounting bolt 228, 226, respectively, extend from an inner surface of frame members 301. Support arm 26 couples between the exposed cap heads 228a, 226a of bolts 228, 226, as previously described. Extension arms 244 are bolted to mount blocks 32, 42, and angled clevis arms 246 are bolted to extension arms 244. When assembled, extension arms 244 extend from frame-mounted mount blocks 32, 42 under each foot board 302, 304, and clevis arms 246 extend under and around foot boards 302, 304 such that the second ends 290 are generally adjacent to foot surfaces 303, 305. Cruise arm assembly 300 provides a rigid frame-mounted foot rest that extends outside of each foot board 302, 304 when foot pegs (not shown) are attached to clevis arms 246.

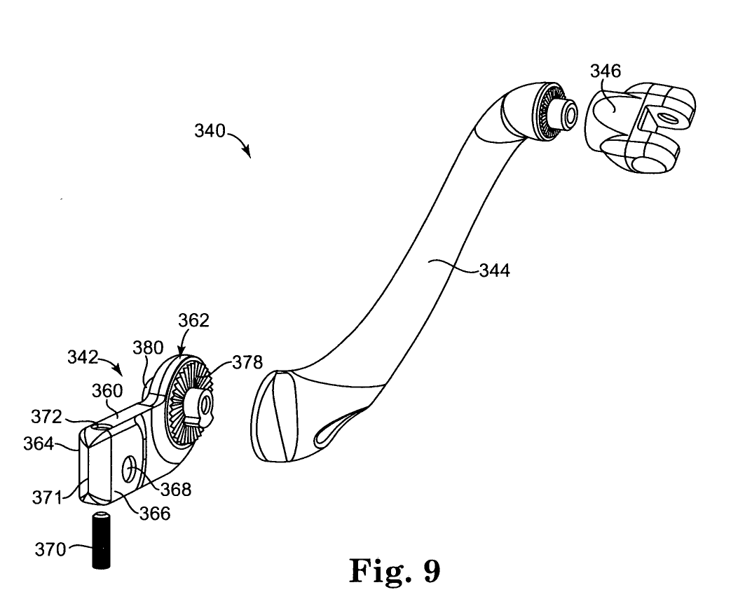

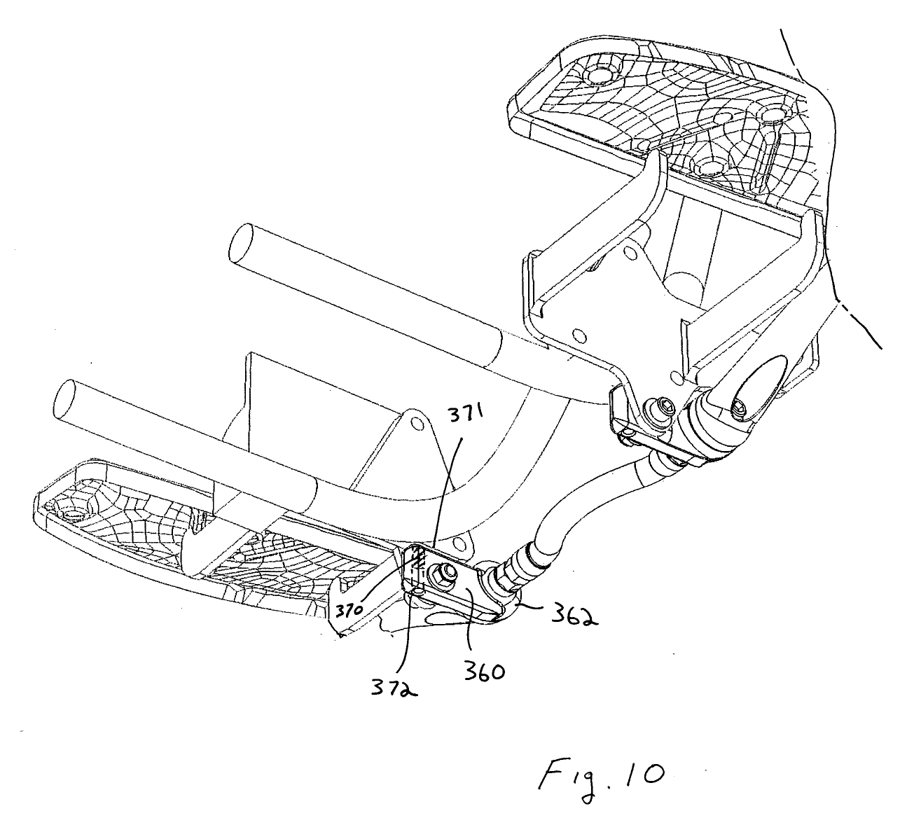

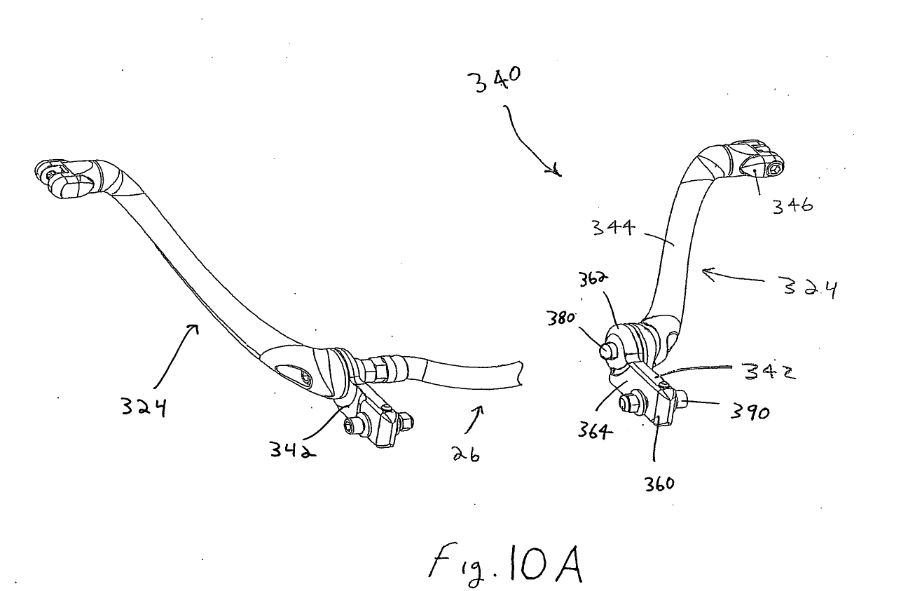

FIG. 9 is a perspective exploded view of another extension arm assembly 340. Extension arm assembly 340 includes a mount block 342 that is attachable to a motorcycle frame, an extension arm 344 that is attachable to mount block 342, and a clevis 346 that is attachable to extension arm 344. Extension arm 344 is similar to extension arm 44 of FIG. 1, and clevis 346 is similar to clevis 46 (FIG. 4).

Mount block 342 includes a body 360 and a head 362 attached to body 360. Body 360 includes a first face 364 opposite a second face 366, and defines a bore 368 therebetween that is configured to receive a bolt/nut suitable for attaching mount block 342 to a motorcycle frame. First face 364 is substantially planar and is configured to be mounted flush to the motorcycle frame. Body 360 further is provided with a bore 372 between the first and second faces 364, 366 adjacent to end 371. Bore 372 extends normal to bore 368 and receives set-screw 370, which can be adjusted to project a desired distance from an upper surface of mount block 342. In this manner, as shown in FIG. 10, when mount block 342 is mounted to the frame by a bolt inserted into bore 368, set-screw 370 can be selectively positioned to index body 360 relative to a portion 371 of the motorcycle frame to limit or prevent pivoting movement of head 362.

Head 362 provides a splined engagement surface 378 that is similar to engagement surface 98 shown in FIGS. 2A and 2B, and additionally includes a post 380 formed opposite of engagement surface 378. Post 380 provides a surface for support arm 26, and specifically cavity 224a, to couple to when support arm 26 is attached to extension arm assembly 340. In one embodiment, post 380 is integrally formed on head 362 of mount block 342.

FIG. 10A is a perspective view of assembled cruise arm assembly 340 as it would appear when attached to a motorcycle frame. A portion of support arm 26 has been removed to better show face 364 and post 380 of mounting block 342. Bolt 390 is provided to attach mount block 342 to a portion of a motorcycle frame. When assembled and attached, extension arm 344 is coupled to engagement surface 378 (FIG. 9), and clevis 346 is coupled to extension arm 344. Extension arm 344 is adjustable relative to mount block 342, and clevis 346 (and a foot peg attached to clevis 346) is adjustable relative to extension arm 344.

Support arm 26 is coupled to head 362 of mount block 342. In particular, cavity 224b (FIG. 5) of outer skirt 222 is configured to engage post 380. In this manner, a pair of opposing extension arm assemblies 324 can be rigidly mounted to a motorcycle frame and braced by support arm 26 that attaches between opposing heads 362 of mount blocks 342. In contrast, cruise arm assembly 20 (FIG. 1) is braced by support arm 26 that extends between bodies 70 (FIG. 2B) of opposing mount blocks 32, 42.

Cruise arm assemblies described above include extension arms that are independently adjustable relative to the frame to provide optimum fore and aft positioning of the extension arms relative to a point of the frame (such as a seat mounted to the frame). The adjustable extension arms offer improved rider comfort, and can be adjusted to accommodate the leg length of the motorcycle rider. A splined head is provided on the mount blocks to essentially lock each extension arm in its desired place. The extension arms can be loosened from engagement with the mount blocks to provide a means for adjusting the extension arms relative to the motorcycle. In addition, a clevis is attached to each extension arm that is independently adjustable relative to the extension arm, which enables a rider to adjust each foot peg for optimum riding comfort.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of adjustable motorcycle cruise arms beyond the specific embodiments discussed herein. Therefore, it is intended that this invention be limited only by the claims and the equivalents thereof.

What is claimed is:

1. A cruise arm assembly configured to be mounted to a motorcycle frame having spaced first and second frame members, each frame member having first and second sides, the cruise arm assembly comprising:
a first arm assembly including:
a first mount block configured for attachment to the first side of the first frame member, and
a first arm having a first end opposite a second end, the first end of the first arm rotatably mountable to the first mount block;
a second arm assembly including:
a second mount block configured for attachment to the first side of the second frame member, and
a second arm having a first end opposite a second end, the first end of the second arm rotatably mountable to the second mount block; and
a support arm having opposing ends, each of the opposing ends of the support arm engaging a respective one of the second sides of each frame member adjacent to the first and second mount blocks.

2. The cruise arm assembly of claim 1, wherein the respective second ends of the first and second arms are configured to receive a foot peg.

3. The cruise arm assembly of claim 1 and further comprising first and second angled arms, each of the first and second angled arms having a first end connected to a respective second end of the first and second arms, and each of the first and second angled arms further having a second end configured to receive a foot peg.

4. A cruise arm assembly configured to be mounted to a motorcycle frame having spaced first and second frame members, each frame member having first and second sides, the cruise arm assembly comprising:
a first arm assembly including:
a first mount block having a first side, a second side, a first end and a second end, the first end of the first mount block configured for attachment to the first side of the first frame member, and
a first arm having a first end and a second end, the first end of the first arm rotatably mountable to the first side of the first mount block adjacent to the second end of the first mount block;
a second arm assembly including:
a second mount block having a first side, a second side, a first end and a second end, the first end of the second mount block configured for attachment of the first side of the second mount block to the first side of the second frame member, and
a second arm including a first end and a second end, the first end of the second arm rotatably mountable to the first side of the second mount block adjacent to the second end of the second mounting block; and
a support arm having opposing ends, each of the opposing ends of the support arm engaging a respective one of the respective second sides of the first and second mount blocks adjacent to the respective second ends of the first and second mount blocks.

5. The cruise arm assembly of claim 4, wherein each second side of the first and second mount blocks comprises a post, wherein the opposing ends of the support arm are configured to engage the posts of the first and second mount blocks.

6. The cruise arm assembly of claim 4, wherein the respective second ends of the first and second arms are configured to receive a foot peg.

7. The cruise arm assembly of claim 4 and further comprising first and second angled arms, each of the first and second angled arms having a first end connected to a respective second end of the first and second arms, and each of the first and second angled arms further having a second end configured to receive a foot peg.
